(19) United States
(12) Patent Application Publication
(10) Pub. No.: US 2007/0078722 A1
(43) Pub. Date: Apr. 5, 2007

(54) System and method for mobile wireless transactions

(76) Inventors: Garurank P. Saxena, Chandler, AZ (US); Parvathy Bhaskaran, Mesa, AZ (US); Prashant Gupta, Schaumburg, IL (US)

Correspondence Address: INGRASSIA FISHER & LORENZ, P.C., 7150 E. CAMELBACK, STE. 325, SCOTTSDALE, AZ, 85251, US

(21) Appl. No.: 11/239,883

(22) Filed: Sep. 30, 2005

(51) Int. Cl. G06Q 30/00

(52) U.S. Cl. 705/26

(57) ABSTRACT

Methods and systems are provided for mobile wireless transactions. The method comprises transmitting (105) a first signal having data indicating a first item, receiving (110) a second signal from a mobile wireless unit in response to the first signal when the mobile wireless unit is within a predetermined proximity to the first item, the second signal indicating a user of the mobile wireless unit seeks an option to purchase the first item, and reserving (115) the option to purchase the first item for a predetermined time period. The system comprises a transmitter (44) configured to transmit a first signal having data indicating a first item, a receiver (46) configured to receive a second signal transmitted by a mobile wireless unit (16) if the mobile wireless unit is within a predetermined proximity to the first item and a user of the mobile wireless unit seeks an option to purchase the first item, and a processor (42) configured to reserve the option to purchase for a predetermined time period.

### FIELD OF THE INVENTION

The present invention generally relates to mobile wireless communications, and more particularly relates to a system and a method for conducting marketplace transactions via mobile wireless communications.

### BACKGROUND OF THE INVENTION

Many marketplaces in the business world are embodied as a traditional brick-and-mortar type marketplace (e.g., a physical storefront) or as an electronic marketplace, such as used for business-to-business (B2B) or business-to-customer (B2C) applications. Marketplaces for customer-to-customer (C2C) applications have also been established to connect potential buyers with sellers, but these marketplaces are generally smaller or limited in scale because of the disproportional resources traditionally associated with customers in comparison with businesses, such as found in B2B or B2C applications.

One example of a common C2C marketplace is a home garage sale. Millions of American households conduct home garage sales each weekend. Newspaper classified advertisements and locally placed signs are typically used to generate awareness and interest in available items at the home garage sale. These methods generally rely upon a primary traffic of potential buyers who actively seek the home garage sale and a secondary traffic of potential buyers who subsequently express an interest in the home garage sale after viewing the advertisement or signs. When potential buyers travel in geographic regions away from the locally placed signs, transactional opportunities derived from secondary traffic may decrease.

Another example of a common C2C marketplace is a web-based marketplace for potential buyers to bid on items offered for sale by sellers. These web-based marketplaces provide some transactional convenience to both the potential buyer and seller. However, physical inspection of the goods is not conveniently possible in pure web-based marketplaces. Buyer access to such web-based marketplaces typically require the buyer to seek out the web-based marketplace, such as by using a personal computer via the Internet, for each instance the buyer desires to interact with the web-based marketplace. While this particular web-based marketplace has seen a growth in user popularity, the web-based marketplace relies on a primary traffic of potential buyers who actively seek the web-based marketplace and overlooks opportunities to add or increase a secondary traffic of potential buyers.

Accordingly, a method for mobile wireless transactions is desired. More particularly, a method for mobile wireless transactions is desired that more efficiently drives traffic to a marketplace. In addition, a system for mobile wireless transactions is desired. Furthermore, other desirable features and characteristics of the present invention will become apparent from the subsequent detailed description of the invention and the appended claims, taken in conjunction with the accompanying drawings and this background of the invention. For example, the present invention allows the combination of allowing physical inspection of purchases with the convenience of a web-based marketplace.

### BRIEF DESCRIPTION OF THE DRAWINGS

The present invention will hereinafter be described in conjunction with the following drawing figures, wherein like numerals denote like elements, and

FIG. 1 is a block diagram of an exemplary embodiment of a system for mobile wireless transaction in accordance with the present invention;

FIG. 2 is a block diagram of an exemplary embodiment of the mobile wireless unit shown in FIG. 1;

FIG. 3 is a block diagram of a exemplary embodiment of the matching system shown in FIG. 1;

FIG. 4 is a flow diagram of an exemplary embodiment of a method for mobile wireless transactions in accordance with the present invention; and

FIG. 5 is a flow diagram of another exemplary embodiment of a method for mobile wireless transactions in accordance with the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description.

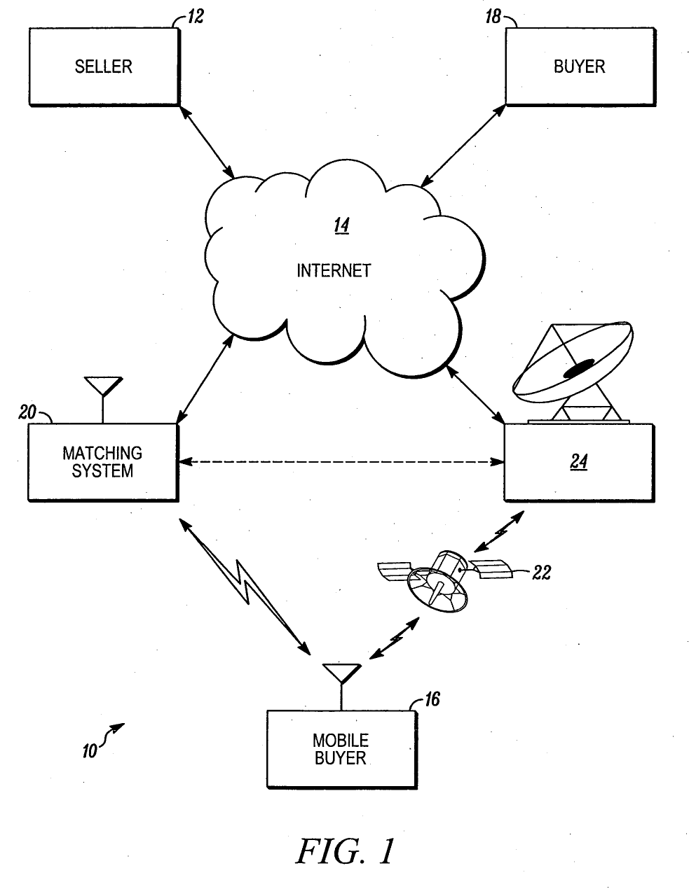

Referring to the drawings, FIG. 1 is a block diagram of an exemplary embodiment of a system 10 for mobile wireless transactions in accordance with the present invention. System 10 comprises a mobile wireless unit 16 and a matching system 20 configured to wirelessly communicate with the mobile wireless unit 16, such as directly via Radio Frequency (RF) transmissions or indirectly via a communications provider 24. Communications provider 24 includes, but is not necessarily limited to, a terrestrial station 24 having direct access to matching system 20 or access to matching system 20 via the Internet, and one or more satellite transponders 22. A variety of wireless communication techniques may be used to transmit information related to system transactions between matching system 20 and mobile wireless unit 16 including, but not necessarily limited to, Bluetooth, Wi-Fi, WiMAX, and cellular mobile communications. Although one mobile wireless unit is described in system 10 for simplicity of discussion, multiple mobile wireless units may be used for additional buyers or sellers in system 10.

In general, a seller 12 accesses matching system 20 via the Internet 14, using for example a personal computer, and submits individual items or a list of items available for purchase to matching system 20. For example, seller 12 logs onto a web-based personal account in matching system 20 and lists products and corresponding prices for sale with a time period and location of the products. A buyer 18 or a user of mobile wireless unit 16 accesses matching system 20, via the Internet 14 or via mobile wireless unit 16, to submit individual items or a list of items desired for purchase by buyer 18. In another exemplary embodiment, the user of mobile wireless unit 16 selects one or more product preferences for comparison by matching system 20 with the products available for purchase. For example, a user of mobile wireless unit 16 having an interest in purchasing products opts-in matching system 20 and provides product preferences and a preferred format for receiving information via mobile wireless unit 16 of products available for purchase that match the product preferences. Matching system 20 compares the list of items available for purchase and the list of items desired for purchase and selects any matches between these lists for transmission to mobile wireless unit 16. Additionally, matching system 20 tracks mobile wireless unit 16 such as via conventional location information provided by a positioning system associated with mobile wireless unit 16 (e.g., via satellite transponder 22 and terrestrial station 24). Seller 12 may update the items available for purchase until an option to purchase a particular available item has been reserved.

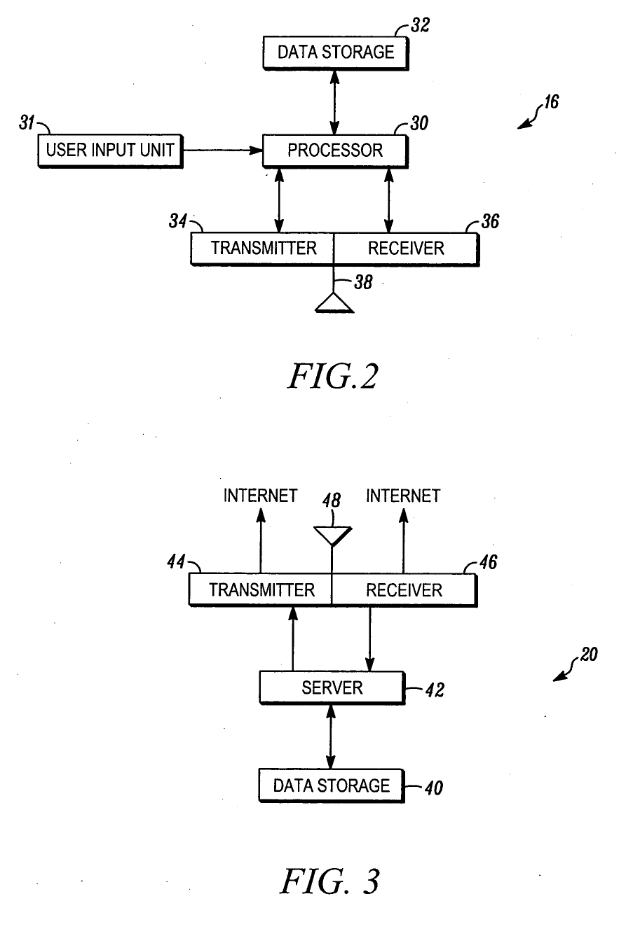

Referring to FIGS. 1 and 2, FIG. 2 is a block diagram of an exemplary embodiment of the mobile wireless unit 16 shown in FIG. 1. Mobile wireless unit 16 comprises a data storage 32, a processor 30 coupled to data storage 32, a transmitter 34 coupled to processor 30, a receiver 36 coupled to processor 30, and a user input unit 31 coupled to processor 30. Transmitter 34 and receiver 36 transmit and receive signals, respectively, via antenna 38. Data storage stores data pertaining to items available for purchase (e.g., received from matching system 20) by the user of mobile wireless unit 16 including, by example and not of limitation, products, prices corresponding to the products, dates of sales for products, and directions to products for sale.

In system 10, initiation of a mobile wireless transaction preferably begins when mobile wireless unit 16 is within a predetermined proximity to the available item. Processor 30 intermittently or continuously determines a location of mobile wireless unit 16, such as by a Global Positioning System function, and this location is transmitted to matching system 20. Processor 30 additionally controls transmitter 34 to transmit a variety of signals to matching system 20 including, but not necessarily limited to, a signal having data indicating the user of mobile wireless unit 16 seeks an option to purchase one or more available items, a signal having data indicating a request to inspect an available item and/or pick-up the available item. In an exemplary embodiment, the user of mobile wireless unit 16 may select the option to purchase or indicate a request (e.g., the request to inspect or the request to pick-up) using input unit 31, such as a touchpad, touch-screen, keyboard, push-button, and the like. Additionally, transmitter 34 may transmit the list of items desired to be purchased by the user of mobile wireless unit 16 or any updates to such list.

To establish and maintain communication in system 10, transmitter 34 includes signal processing circuitry for up-linking to satellite transponder 22, modulation, coding, and the like. Receiver 36 includes signal processing circuitry for down-linking with satellite transponder 22, demodulation, decoding, and the like. Transmitter 34 and receiver 36 may include signal processing circuitry for a variety of RF based communication techniques. Receiver 36 receives a variety of signals transmitted from matching system 20 including, but not necessarily limited to, a signal having data indicating one or more available items for purchase and a signal having data indicating directions to available items for purchase. After extracting the data contained in the signals received from matching system 20, receiver 36 transfers the data to processor 30. For example, receiver 36 extracts data pertaining to an available item for purchase (e.g., product type, price, and location of the product) and processor 30 displays such data at user input unit 31.

Referring to FIGS. 1 and 3, FIG. 3 is a block diagram of an exemplary embodiment of the matching system shown in FIG. 1. Matching system 20 comprises a data storage 40, a server 42 coupled to data storage 40, a transmitter 44 having an input coupled to server 42 and an output configured to couple to the Internet 14, and a receiver 46 having an input configured to couple to the Internet 14 and an output coupled to server 42. Transmitter 44 and receiver 46 transmit and receive signals, respectively, via antenna 48, such as for wireless communication with mobile wireless unit 16, and provide network connectivity with seller 12 and buyer 18 via the Internet 14. Data storage 40 stores a variety of transactional information including, by way of example and not of limitation, available items for purchase, locations of the available items, corresponding prices, reserved options and time periods of such options, and dates for inspection and pick-up of available items. Additionally, data storage 40 stores information provided by buyer 18 to server 42 or via mobile wireless unit 16 such as the product preferences.

Server 42 compares the available items for purchase with the product preferences of the user to produce matches. Server 42 determines when mobile wireless unit 16 is within a predetermined proximity (e.g., a geographical region or a distance) to any of the matched items and controls transmitter 44 to transmit a signal indicating that such item is available for purchase. Examples of proximities include within a city, within a state, within a distance, etc. By matching available items for purchase with the product preferences of the user and alerting the user when the mobile wireless unit 16 is within the predetermined proximity, system 10 more efficiently drives both primary traffic and secondary traffic to the marketplace. The user can set preferences that shall be used by Server 42. Examples of such preferences include, but are not limited to, the Server using such preferences to determine whether the user is interested in receiving notifications about items, or whether the user is interested in making the purchase.

In addition to transmitting signals indicating available items for purchase, transmitter 44 transmits a variety of other signals. For example, in response to requests from mobile wireless unit 16, transmitter 44 transmits a signal having data indicating a scheduled date/time for inspection of an available item, a signal having data indicating a scheduled date/time for pick-up of an available item, and a signal having directions to the available item. Receiver 46 receives a variety of signal transmitted from mobile wireless unit 16 including, but not necessarily limited to, a signal indicating the location of mobile wireless unit 16, a signal indicating the user of mobile wireless unit 16 seeks an option to purchase an available item, a signal reserving a date/time for inspection of the available item, a signal reserving a date/time for pick-up of the available item, and a signal indicating product preferences or items desired by the user of mobile wireless unit 16. Transmitter 44 and receiver 46 may communicate with mobile wireless unit 16 via a network connection to the Internet 14 and transmission using terrestrial station 24 and satellite transponder 22. In another exemplary embodiment, transmitter and receiver 46 may directly communicate with mobile wireless unit 16 and include conventional signal processing circuitry for RF based communication.

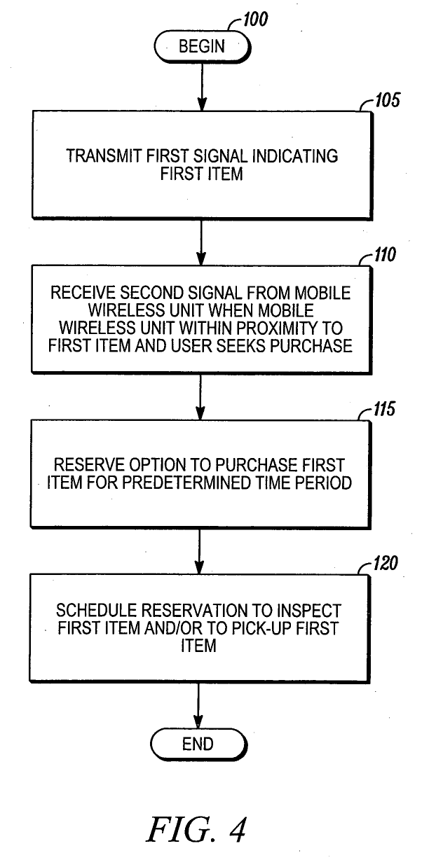

FIG. 4 is a flow diagram of an exemplary embodiment of a method for mobile wireless transactions in accordance with the present invention. Referring to FIGS. 1 and 4, the method begins at step 100. Matching system 20 transmits a first signal having data indicating a first available item for purchase at step 105. In an exemplary embodiment, matching system 20 transmits the first signal after determining that mobile wireless unit 16 is within a predetermined proximity to the first item. Matching system 20 receives a second signal from mobile wireless unit 16 that indicates the user of mobile wireless unit 16 seeks an option to purchase the first available item at step 110. Mobile wireless unit 16 transmits the second signal if mobile wireless unit 16 is within the predetermined proximity to the first available item and the user of mobile wireless unit 16 seeks an option to purchase the first item. Matching system 20 reserves this option to purchase the first available item for a predetermined time period at step 115. Matching system 20 schedules a reservation to inspect the first available item and/or to pick-up the first available item upon receipt of a third signal from mobile wireless unit 16 at step 120. Matching system 20 may additionally receive a list of available items for purchase from seller 12 (e.g., via the Internet) and a list of desired items from buyer 18 or mobile wireless unit 16. Matching system 20 compares these lists and selects the first available item from any matches of items on both lists. Additionally, matching system 20 determines directions from mobile wireless unit 16 to the first available item and transmits the directions to mobile wireless unit 16.

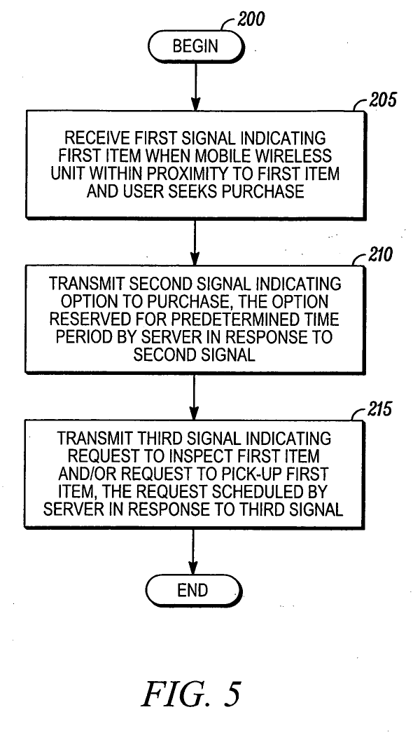

FIG. 5 is a flow diagram of another exemplary embodiment of a method for mobile wireless transactions in accordance with the present invention. Referring to FIGS. 1 and 5, the method begins at step 200. Mobile wireless unit 16 receives a first signal transmitted from matching system 20 that indicates a first available item for purchase. Matching system 20 transmits the first signal when mobile wireless unit 16 is within a predetermined proximity to the first available item and the user of mobile wireless unit 16 desires the first available item. Mobile wireless unit 16 transmits a second signal indicating the user of mobile wireless unit 16 desires an option to purchase the first available item at step 210. Matching system 20 reserves this option for a predetermined time period in response to the second signal. Mobile wireless unit 16 transmits a third signal indicating a user request to inspect the first available item and/or pick-up the first available item at step 215. Matching system 20 schedules this request in response to the third signal. Additionally, mobile wireless unit 16 transmits a list of items desired by the user of mobile wireless unit 16 to matching system 20. Matching system 20 selects the first available item from any matches between this list of items desired by the user of mobile wireless unit 16 and a list of available items for purchase. Mobile wireless unit 16 may additionally receive directions to the first available item from matching system 20.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for mobile wireless transactions, the method comprising:
transmitting a first signal having data indicating a first item;
receiving a second signal from a mobile wireless unit in response to the first signal when the mobile wireless unit is within a predetermined proximity to the first item, the second signal indicating a user of the mobile wireless unit seeks an option to purchase the first item; and
reserving the option to purchase the first item for a predetermined time period.

2. A method according to claim 1 further comprising:
receiving a request transmitted by the mobile wireless unit, the request indicating the user of the mobile wireless unit seeks to inspect the first item; and
scheduling a reservation based on the request.

3. A method according to claim 1 further comprising:
receiving a request transmitted by the mobile wireless unit, the request indicating the user of the mobile wireless unit seeks to obtain possession of the first item; and
scheduling a reservation based on the request.

4. A method according to claim 1 further comprising:
receiving first and second lists of items, the first list of items desired by the user of the mobile wireless unit, each item of the second list of items having a location;
matching at least one item between the first and second lists of items; and
selecting the first item from the at least one item if the mobile wireless unit is within the predetermined proximity to the first item.

5. A method according to claim 1 further comprising transmitting directions to the first item to the mobile wireless unit.

6. A method for mobile wireless transactions, the method comprising:
receiving a first signal transmitted by a server when a mobile wireless unit is within a predetermined proximity to a first item and a user of the mobile wireless unit seeks the first item, the first signal having data indicating the first item; and
transmitting a second signal having data indicating the user of the mobile wireless unit seeks an option to purchase the first item, the option reserved for a predetermined time period by the server in response to the second signal.

7. A method for mobile wireless transactions according to claim 6 further comprising transmitting a third signal having data indicating a request by the user of the mobile wireless unit to inspect the first item, the request scheduled by the server in response to the third signal.

8. A method according to claim 6 further comprising transmitting a third signal having data indicating a request by the user of the mobile wireless unit to obtain possession of the first item, the request scheduled by the server in response to the third signal.

9. A method according to claim 6 further comprising transmitting a third signal having data indicating a list of items desired by the user of the mobile wireless unit, the list of items stored by the server in response to the third signal, the first item selected by the server from the list of items.

10. A method according to claim 6 further comprising receiving directions to the first item transmitted by the server.

11. A system for mobile wireless transactions, the system comprising:
a transmitter configured to transmit a first signal having data indicating a first item;
a receiver configured to receive a second signal transmitted by a mobile wireless unit in response to said first signal, said second signal indicating if said mobile wireless unit is within a predetermined proximity to said first item and a user of said mobile wireless unit seeks an option to purchase said first item;
a data storage configured to store a first list of items desired by said user of said mobile wireless unit; and
a processor coupled to said data storage, said transmitter, and said receiver, said processor configured to:
select said first item from said first list of items; and
reserve said option to purchase said first item for a predetermined time period.

12. A system according to claim 11, wherein said receiver is further configured to receive a request transmitted by said mobile wireless unit, said request transmitted by said mobile wireless unit if said user of said mobile wireless unit seeks to inspect said first item, and wherein said processor is further configured to schedule a reservation based on said request.

13. A system according to claim 11, wherein said receiver is further configured to receive a request transmitted by said mobile wireless unit, said request transmitted by said mobile wireless unit if said user of said mobile wireless unit seeks to obtain possession of said first item, and wherein said processor is further configured to schedule a reservation based on said request.

14. A system according to claim 11, wherein said data storage is further configured to store a second list of items, each item of said second list of items having a location;
wherein said receiver is further configured to receive said first list of items transmitted by said mobile wireless unit; and
wherein said processor is further configured to:
match at least one item between said first list of items and said second list of items; and
select said first item from said at least one item.

15. A system according to claim 11, wherein said processor is further configured to produce directions to said first item, and wherein said transmitter is further configured to transmit said direction to said first item.

16. An apparatus for mobile wireless transactions, the apparatus comprising:
a processor configured to determine a location of the apparatus;
a receiver coupled to said processor and configured to receive a first signal having data indicating a first item, the first signal transmitted by a server if apparatus is within a predetermined proximity to said first item and a user of the apparatus seeks said first item;
a transmitter coupled to said processor and configured to transmit a second signal having data indicating said user of the apparatus seeks an option to purchase said first item, said option to purchase said first item reserved by said server for a predetermined time period in response to said second signal; and
a data storage coupled to said processor and configured to store a list of items desired by said user of the apparatus.

17. An apparatus according to claim 16, wherein said receiver is further configured to receive directions to said first item transmitted by said server, and wherein said data storage is further configured to stored said directions to said first item.

18. An apparatus according to claim 16, wherein said transmitter is further configured to transmit a third signal having data indicating a request by said user of the apparatus to inspect said first item, said request scheduled by said server in response to said third signal.

19. An apparatus according to claim 16, wherein said transmitter is further configured to transmit a third signal having data indicating a request by said user of the apparatus to obtain possession of said first item, said request scheduled by said server in response to said third signal.

20. An apparatus according to claim 16, wherein said transmitter is further configured to transmit a third signal having data indicating said location of the apparatus and said list of items desired by said user of the apparatus, said list of items stored by said server in response to said third signal, said first item selected by said server from said list of items.
